(19) United States
(12) Patent Application Publication
(10) Pub. No.: US 2003/0016537 A1
(43) Pub. Date: Jan. 23, 2003

(54) Soft shell for a lighting bulb assembly

(76) Inventor: Yu-Peng Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/020,180

(22) Filed: Dec. 18, 2001

(30) Foreign Application Priority Data
Jul. 20, 2001 (KR) 2001-0043714

(51) Int. Cl. F21V 1/16

(52) U.S. Cl. 362/311; 362/294; 362/278; 362/351

(57) ABSTRACT

The present invention relates to a soft shell for a lighting bulb assembly. The soft shell can be connected with a bulb of the bulb assembly directly. Since the shell is heat-conductible, it can dissipate heat produced by the lighting bulb efficiently. While the shell is soft, it has variable outlook in use that increases obviously decorative effect.

### BACKGROUND OF THE INVENTION

A conventional lighting bulb assembly (2) is usually provided with a rigid shell (1), as shown in FIG. 1, which connects with a bulb holder (21) of the bulb assembly (2) and can be patterned with a large decorative outlook. The prior rigid shell (1) has a rigid shape only and when it connects with the bulb assembly (2), there becomes a sealed space around a bulb (22). As the bulb (22) is lightened, it produces heat that is difficult to be dissipated and makes high temperature in the space. Under this situation, the bulb (22) will be more possibly broken.

Accordingly, the primary object of the invention is to provide a new decorative lighting bulb assembly with a soft shell, which will be easily connected with the bulb and the heat produced by the bulb can be efficiently dissipated. Now the features and advantages of the present invention will be described in detail with reference to the accompanying drawings.

### BRIEF DESCRIPTION OF ACCOMPANYING DRAWINGS

FIG. 1 is a cross-sectional perspective view showing a known rigid shell connected with a lighting bulb assembly.

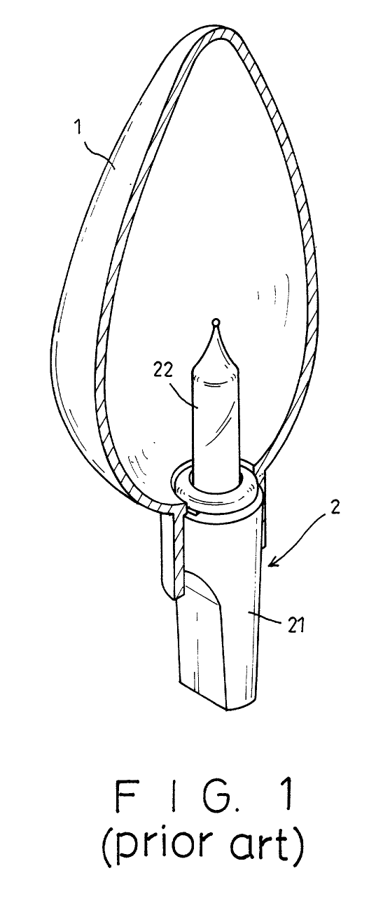

FIG. 2 is a cross-sectional perspective view showing a soft shell connected with a lighting bulb assembly according to the present invention.

FIG. 3 is a plan view showing an exemplary embodiment of a lighting string connected with the lighting bulb assembly according to the present invention.

### DETAILED DESCRIPTION OF PREFERRED EMBODIMENTS

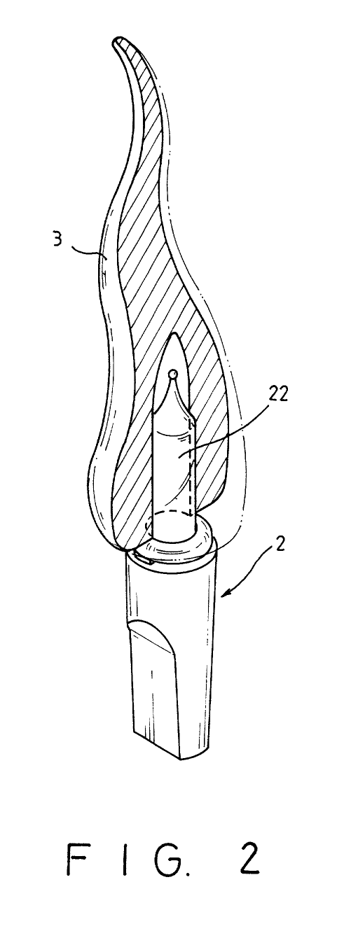

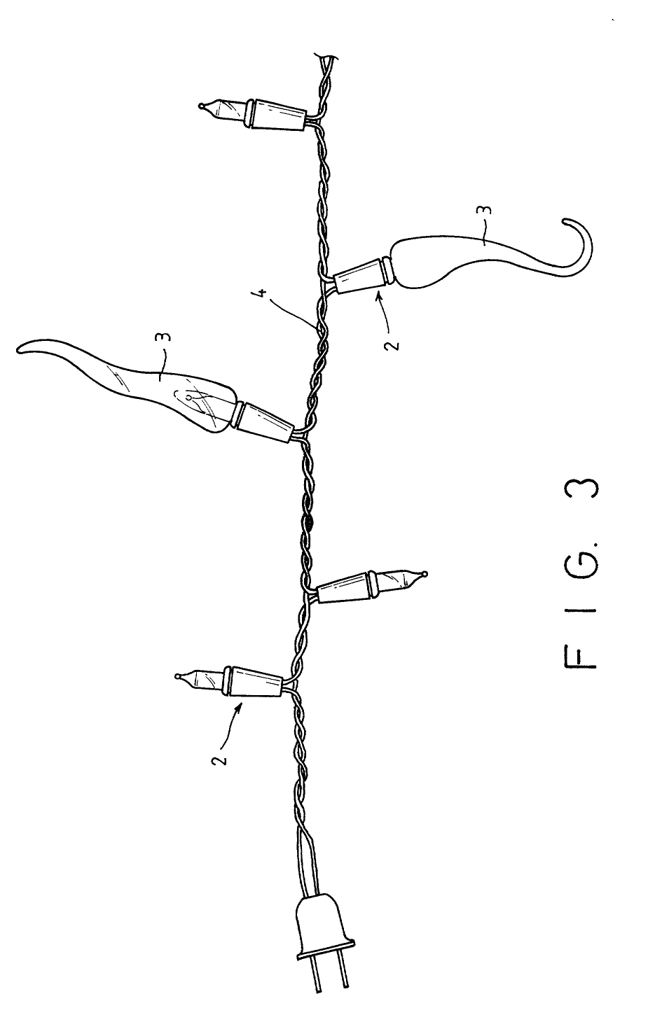

Please refer to FIGS. 2 and 3, the present invention relates to an improvement of a lighting bulb assembly of a decorative lighting string. The most characteristic is in that a soft shell (3) is provided to connect with a bulb (22) of the bulb assembly (2) directly. The soft shell is made of transparent or semi-transparent material, which is also possible heat-conductible. When the bulb (22) is lightened and heated, the heat can be dissipated by the soft shell (3) efficiently. Moreover, light of the bulb (22) can be emitted through the transparent shell (3) to become a special decorative effect. And accompanying with variable shape of the soft shell (3), the lighting bulb assembly (2) connected by electrical wire (4) can obviously obtain an invented novel decorative utility.

Accordingly, the present invention provides an invented structure with improvement, which uses a better connection by the soft shell for increasing decorative and dissipated effect. It obviously gains the utility and novelty for patent and is thus applied.

What is claimed is:

1. A soft shell for a lighting bulb assembly including the soft shell being connected with a bulb of the bulb assembly directly and being transparent or semi-transparent, heat-conductible, and variable outlook.
